(19) United States
(12) Patent Application Publication
(10) Pub. No.: US 2022/0396113 A1
(43) Pub. Date: Dec. 15, 2022

(54) ADVANCED ELECTRONICALLY CONTROLLED AIR SUSPENSION (ECAS) SYSTEM WITH IMAGE SENSORS

(71) Applicant: Hak Soo Kim, San Diego, CA (US)

(72) Inventor: Hak Soo Kim, San Diego, CA (US)

(21) Appl. No.: 17/832,987

(22) Filed: Jun. 6, 2022

Related U.S. Application Data
(60) Provisional application No. 63/209,575, filed on Jun. 11, 2021.
(60) Provisional application No. 63/235,355, filed on Aug. 20, 2021.

(51) Int. Cl. B60G 17/0165; B60G 17/015; B60G 17/018; B60G 17/019

(52) U.S. Cl. CPC B60G 17/0165; B60G 17/0155; B60G 17/018; B60G 17/019; B60G 2202/242; B60G 2400/204; B60G 2400/252; B60G 2400/821; B60G 2401/14; B60G 2500/11

(57) ABSTRACT

This application relates to an electronically controlled air suspension (ECAS) system. When a vehicle starts, the ECAS system receives data from a wheel height sensor and sets the received height as a default height. When driving, a high-speed line profiler scans the road surface in front of the tires of the vehicle. This information is processed by an image processing unit to determine the amount of air in the corresponding damper. If there is a bump on the road, the ECAS system may reduce the amount of air on the tire side in advance, and if there is a dip, the ECAS system may increase the amount of air on the tire side in advance to minimize vibration. Regarding the residual vibration after passing through the bump or dip, the amount of air is adjusted so that the vibration stops quickly by receiving real-time data from the wheel height sensor.

### CROSS-REFERENCE TO RELATED APPLICATIONS

Any and all priority claims identified in the Application Data Sheet, or any correction thereto, are hereby incorporated by reference under 37 CFR 1.57. This application claims the benefit of U.S. Provisional Application Nos. 63/209,575 and 63/235,355, filed Jun. 11, 2021 and Aug. 20, 2021, respectively. The aforementioned applications are incorporated by reference herein in their entirety, and are hereby expressly made a part of this specification.

### TECHNICAL FIELD

The present disclosure generally relates to a vehicle suspension system. For example, the present disclosure relates to an electronically controlled air suspension (ECAS) system and a method of operating the ECAS system, and a vehicle including the ECAS system.

### SUMMARY

For more comfortable driving, the vibration of a vehicle can be predicted and controlled in advance using electronic devices, such as image sensor. Thus, the present disclosure relates to predicting vibration of the vehicle with image sensors and controlling an electronic air suspension system. Further, the present disclosure relates to an advanced, electronically controlled air suspension (ECAS) system with image sensors.

The present disclosure can be applied to a new vehicle design and also can be applied to existing vehicles with modification of the existing vehicles. It detects bump or dip in front of the vehicle in advance and then controlling air suspension by adjusting the air volume or air pressure in the damper until the remaining vibration stops.

In some embodiments, the principle of operation is as follows. When a vehicle starts, an ECAS device receives data from a wheel height sensor and sets the received height as a default height. When driving, a high-speed line profiler scans the road surface in front of one or more of the tires of the vehicle. This information is processed by an image processing unit (or an image processor) to determine the amount of air in the corresponding damper. If there is a bump on the road, the ECAS device may reduce the amount of air on the tire side in advance, and if there is a dip, the ECAS device may increase the amount of air on the tire side in advance to minimize vibration. Regarding the residual vibration after passing through the bump or dip, the amount of air is adjusted so that the vibration stops quickly by receiving real-time data from the height sensor. If another obstacle (bump or dip) is found in the middle of controlling the residual vibration, the residual vibration control is stopped, the amount of vibration of the other obstacle is recalculated, and the amount of air is adjusted in advance when the time comes to take measures for other vibration.

The present disclose provides a system and method of predicting vibration of a vehicle with image sensors and controlling an electronic air suspension device based on the predicted vibration, the system comprising a height sensor detecting a ground clearance of a vehicle; a high-speed line profiler scanning a road surface in front of a tire and determine a bump or a dip on the road surface; and a processor configured to set the detected ground clearance as a default height upon starting the engine of the vehicle and determine an amount of air in a corresponding damper of the electronic air suspension device based on the scanned road surface such that when the bump or dip is detected, the amount of air is reduced or increased accordingly on the tire side in advance to minimize vibration, and that the amount of air is further adjusted right after passing the bump or dip to further decrease residual vibration based on real-time data received from the height sensor.

One aspect of the present disclosure provides a method of controlling an air suspension of a vehicle for reducing shock and vibration when the vehicle passes a bump or a dip, which may comprise: providing a vehicle comprising: a vehicle wheel, a vehicle body, an air suspension connecting the vehicle wheel and the vehicle body and supporting the vehicle body, the air suspension comprising an air strut, an air inlet valve, and an air outlet valve, an air compressor supplying air to the air strut via the air inlet valve, a plurality of sensors comprising a vehicle speed sensor, a steering angle sensor, a height sensor and an air pressure sensor of the strut, a line profiler comprising an image sensor located in front of the vehicle wheel such that the line profiler acquires a profile of a road on which the vehicle wheel passes, a processor configured to process information from the plurality of sensors and the line profiler for predicting the vehicle's vibration and further configured to control operations of one or more of the air inlet valve, the air outlet valve and the air strut for reducing shock and vibration caused by the bump or dip; while the vehicle moves, scanning, by the line profiler, a road on which the vehicle moves for acquiring the profile of the road and locating a bump or a dip; processing, by the processor, the information from the plurality of sensors and the profile of the road; and controlling, by the processor, the operation of the air suspension by increasing or decreasing air supplied to the air strut via the air inlet valve or discharged from the strut via the air outlet valve based on the profile of the road and the speed of the vehicle for reducing vibration when the vehicle passes the bump or dip.

The foregoing method may further comprise: after passing the bump or dip, further controlling, by the processor, the operation of the air suspension by increasing or decreasing air supplied to the air strut or discharged from the strut based on the wheel height and the vehicle speed for reducing a residual vibration. The method may further comprise: when starting an operation of the vehicle, detecting a height with the wheel height sensor for setting the detected wheel height as a reference height, and detecting an air pressure of the strut with the air pressure sensor for setting the detected air pressure as a reference air pressure, wherein controlling is performed further based on the reference height and the reference air pressure.

Another aspect of the present disclosure provides a non-transitory computer readable medium storing instructions for performing any one of the foregoing methods.

Still another aspect of the present disclosure provides an air suspension system for use with a vehicle, which may comprise: an air suspension connecting a vehicle wheel and a vehicle body and supporting the vehicle body, the air suspension comprising an air strut, an air inlet valve, and an air outlet valve; an air compressor configured to supply air to the air strut via the air inlet valve; a plurality of sensors comprising a vehicle speed sensor, a steering angle sensor, a wheel height sensor and an air pressure sensor of the strut; a line profiler comprising an image sensor located in front of the vehicle wheel and configured to acquire a profile of a road on which the vehicle wheel passes to locate a bump or a dip; and a processor configured to process information from the plurality of sensors and the line profiler for predicting the vehicle's vibration and further configured to control operations of one or more of the air inlet valve, the air outlet valve and the air strut for reducing shock and vibration caused by the bump or dip.

A further aspect of the present disclosure provides a vehicle comprising the foregoing air suspension system.

In the foregoing vehicle, the vehicle may be an electric vehicle, a combustion based vehicle, a hybrid vehicle or a motor cycle.

### BRIEF DESCRIPTION OF THE DRAWINGS

FIG. 1 is a side view of a vehicle comprising example sensors that can be used for an ECAS system according to some embodiments.
FIG. 1 shows that there is a line profiler (e.g., a linear image sensor) on the front of each tire or vehicle wheel. (4 sensors), Back side can be optional. FIG. 1 shows the following elements.
100: Vehicle
102: Object or obstacle (Bump)
104: Tire
311: Line Profiler (image sensor)
330: Steering Wheel Angle Sensor module
312: Height Sensor module
313: Air Pressure Sensor module

FIG. 2 is a top view of a portion of the vehicle comprising example sensors that can be used for the ECAS system according to some embodiments.
FIG. 2 shows just one wheel. This system has 4 line profilers. FIG. 2 shows the following elements.
202: Axle
204: Scan Line
100: Vehicle
102: Object or obstacle (Bump)
104: Tire
311: Line Profiler
312: Height Sensor module
313: Air Pressure Sensor module
314: Strut (Air type)
315: Inlet Solenoid Valve (Air Valve)
316: Outlet Solenoid Valve (Air Valve)

FIG. 3 is an example block diagram of the ECAS system according to some embodiments. FIG. 3 shows the following elements.
310: Wheel Components
320: Image Processing and Control Unit
330: Steering Wheel Angle Sensor
340: Vehicle Speed Sensor Module
350: Air Compressor

FIG. 4 is another example diagram of the ECAS system processing signals from each wheel component (310) according to some embodiments. FIG. 4 shows the following elements.
311: Line Profiler
312: Height Sensor module
313: Air Pressure Sensor Module
314: Strut (Air Type)
315: Inlet Solenoid Valve (Air Valve)
316: Outlet Solenoid Valve (Air Valve)

FIG. 5 shows example images taken from a line profiler according to some embodiments. FIG. 5 shows the following elements.
202: Axle
204: Scan Line
100: Vehicle
102: Object, Bump
104: Tire
311: Line Profiler
500: Reference profile line for height
502, 504, 506: captured profile lines
508: Vehicle Direction, when going straight
510: Vehicle Direction, when making a turn

FIG. 6 shows an example line profile image data of the captured profile line 502 according to some embodiments.

FIG. 7 shows an example line profile image data of the captured profile line 504 according to some embodiments.

FIG. 8 shows an example line profile image data of the captured profile line 506 according to some embodiments.

FIG. 9 shows an example timing diagram for a bump according to some embodiments. FIG. 9 shows the following elements.
315: Inlet Solenoid Valve (Air Valve)
316: Outlet Solenoid Valve (Air Valve)
901: Reference Height
902: Conventional Vehicle's vibration
904: Controlled Vibration
906: Residual Bounce Start Point
920: 316's Open Point
922: 316's Close Point
930: 315's Open Point
932: 315's Close Point

FIG. 10 shows example images taken from a line profiler according to some embodiments. FIG. 10 shows the following elements.
202: Axle
204: Scan Line
100: Vehicle
1102: Object, Dip
104: Tire
311: Line Profiler
1000: Reference profile line for height
1002, 1004, 1006: captured profile lines
1008: Vehicle Direction, when going straight
1010: Vehicle Direction, when making a turn

FIG. 11 shows an example line profile image data of the captured profile line 1002 according to some embodiments.

FIG. 12 shows an example line profile image data of the captured profile line 1004 according to some embodiments.

FIG. 13 shows an example line profile image data of the captured profile line 1006 according to some embodiments.

FIG. 14 shows an example timing diagram for a dip according to some embodiments. FIG. 14 shows the following elements.
315: Inlet Solenoid Valve (Air Valve)
316: Outlet Solenoid Valve (Air Valve)
901: Reference Height
1402: Conventional Vehicle's vibration
1404: Controlled Vibration
1406: Residual Bounce Start Point
1420: 316's Open Point
1422: 316's Close Point
1430: 315's Open Point
1432: 315's Close Point

FIG. 15A and FIG. 15B show an example flowchart for an operation of the ECAS system according to some embodiments.

FIG. 16A is a side view of a vehicle comprising example sensors that can be used for an ECAS system according to other embodiments where a wide-angle line profiler (image sensor, 360) has been added instead of front line profilers (311) of FIG. 1.

FIG. 16B is a top view of a portion of the vehicle comprising example sensors that can be used for the ECAS system according to other embodiments where the wide-angle line profiler (image sensor, 360) has been added instead of the front line profilers (311) of FIG. 2.

FIG. 17A is a side view of a vehicle comprising example sensors that can be used for an ECAS system according to other embodiments where a wide-angle line profiler (image sensor, 360) has been added and existing front line profilers (311) have been disabled.

FIG. 17B is a top view of a portion of the vehicle comprising example sensors that can be used for the ECAS system according to other embodiments where the a wide-angle line profiler (image sensor, 360) has been added and existing front line profilers (311) have been disabled.

FIGS. 1-17B are merely example diagrams showing elements or charts only for a description purpose. Depending on embodiments, the described technology can include more or less elements, and different charts and diagrams can be used.

### DETAILED DESCRIPTION

As shown in FIG. 1, in embodiments, the vehicle includes an air suspension system that precisely controls the amount of air in the Strut (Air type) (314) in real time by applying the distance measurement technology using the line profiler (311) to minimize vibration during driving regardless of the road condition. The purpose is to have a comfortable ride. The steering wheel angle sensor module (330) detects rotation of the steering wheel and transmits a signal to the image processing & control unit (320) as a digital value. In embodiments, the range of values is set to zero degrees when going straight, and the value increases (plus number) as the tire or vehicle wheel rotates to the right, and the value decreases (minus number) as the tire or vehicle wheel rotates to the left. The speed of the vehicle is a digital value from the speed sensor module (340), which is received and analyzed by the image processing & control unit (320). When stopped, it is zero, and the faster the speed, the larger the value.

As shown in FIG. 2, FIG. 3 and FIG. 4, in embodiments, for each vehicle wheel, the air suspension system has a Strut (Air type) (314), a height sensor module (312), a line profiler (311), and an air pressure sensor, an air pressure sensor module (313) and two solenoids (315 and 316) (one for air injection and the other for air discharge) are required. These are called Wheel Components (310).

In embodiments, the vehicle includes an air compressor (350), a speed sensor module (340), a steering wheel angle sensor module (330) and an image processing & control unit (320). The image processing & control unit 320 analyzes the information received from the four line profilers (311) and controls each Strut (314) appropriately. Each height sensor module (312) generates digital values in synchronization with the height of the wheel. When the height of the wheel increases, the value is changed and a signal is transmitted to the image processing & control unit (320). The inlet solenoid valve (315) receives air from the air compressor (350) and injects air into the strut (314). The amount of air injected can be controlled when the inlet solenoid valve (315) is opened by receiving an electric signal from the image processing & control unit (320), and the outlet solenoid valve (316) has the purpose of discharging air from the strut (314). The amount of air discharged can be controlled when the outlet solenoid valve is opened by receiving an electric signal from the image processing & control unit (320). The air pressure sensor module (313) detects the amount of air in the strut (314) and send to image processing & control unit (320). The purpose is to control appropriate air flow when the amount of air is too large or too small due to abnormal operation.

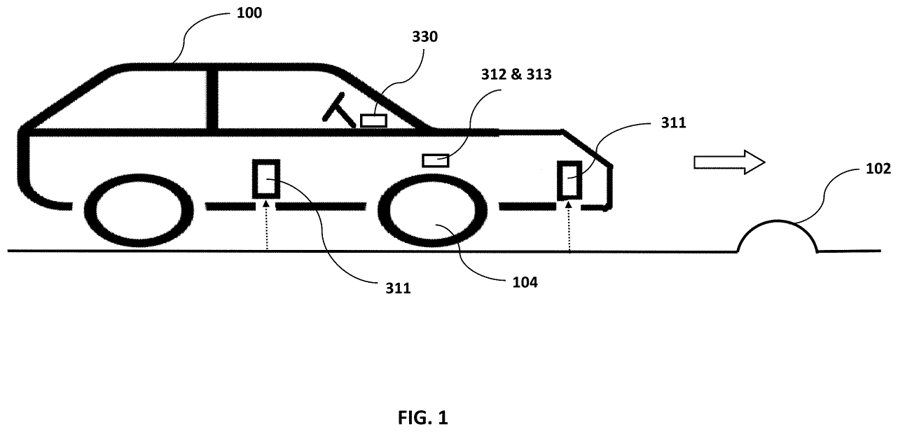

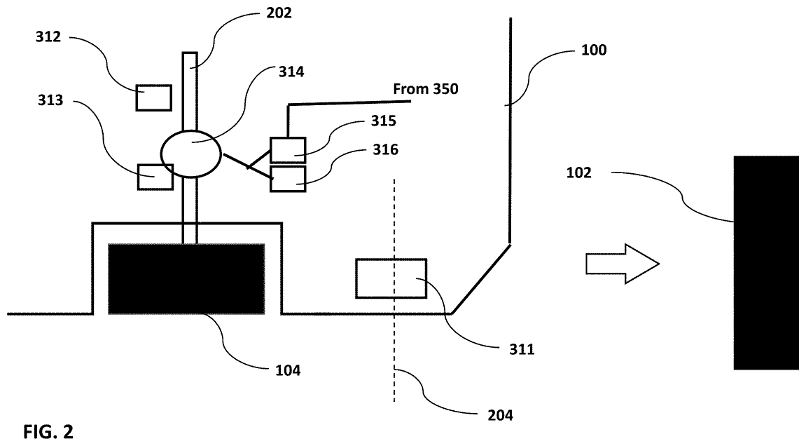

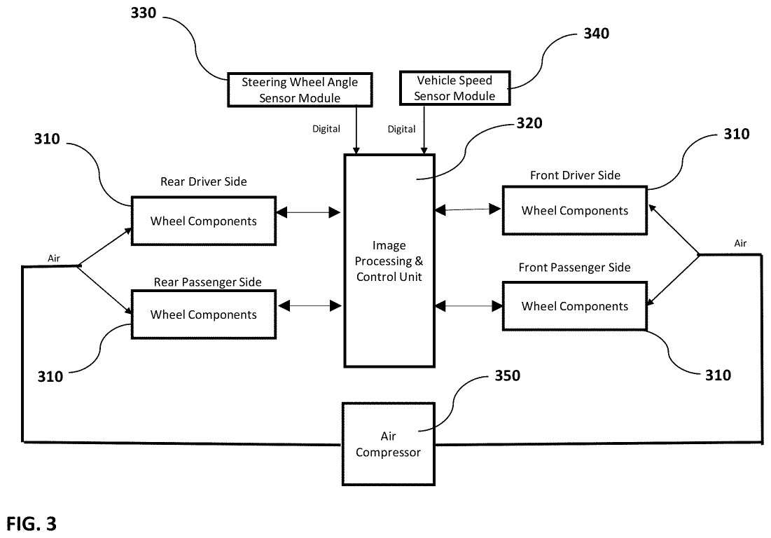

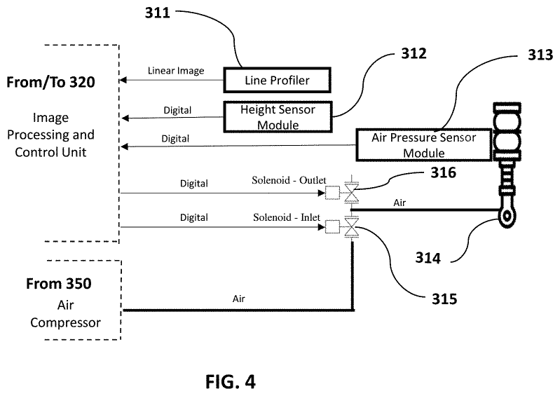

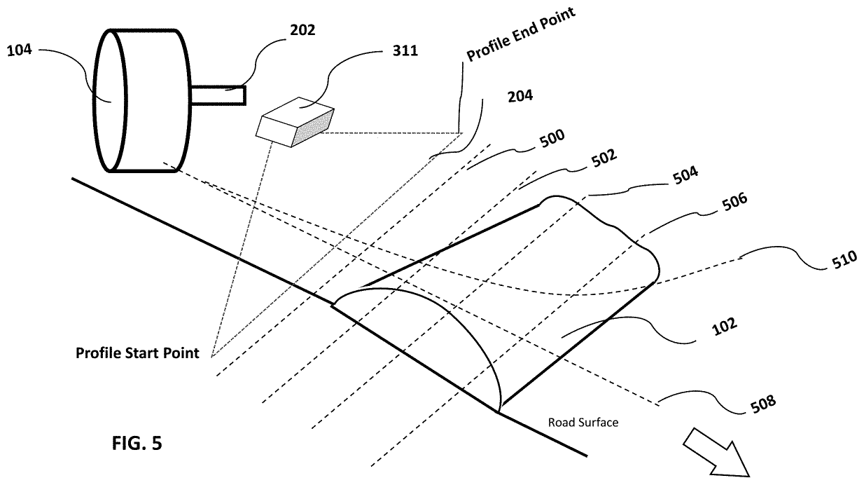

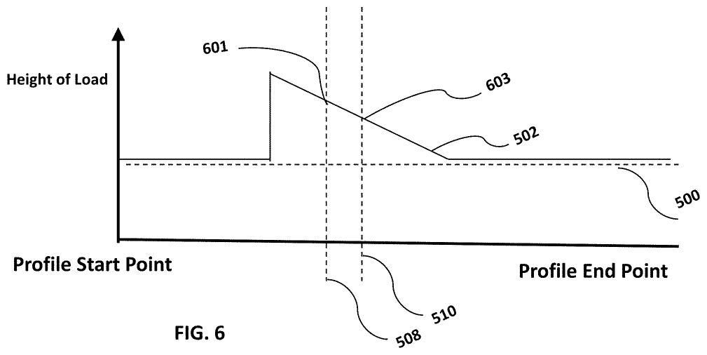

The detailed operation is as follows. As shown in FIG. 5, an example is taken that the vehicle wheel (104) of the Vehicle (100) goes straight or makes a turn through the bump (102). Line Profiler (311) scans (204) obstacles in front of the tire in real time. FIG. 6 to FIG. 8 show the image data of the road condition by time scanned from the line profiler (311). The line profiler (311) scans the height of the obstacle on the road surface where the vehicle will pass.

This information is transmitted to the image processing & control unit (320) and processed. The image processing & control unit (320) stores the speed and the steering wheel angle of the vehicle together when saving the image scanned by the line profiler (311). Each capture timing depends on the vehicle's speed. The image processing & control unit (320) determines whether to control the Strut by analyzing how much impact the object can give to the vehicle by processing the captured 3D data. In embodiments, if the object is small and is not shocked even if it passes by, ignore it and process the next data.

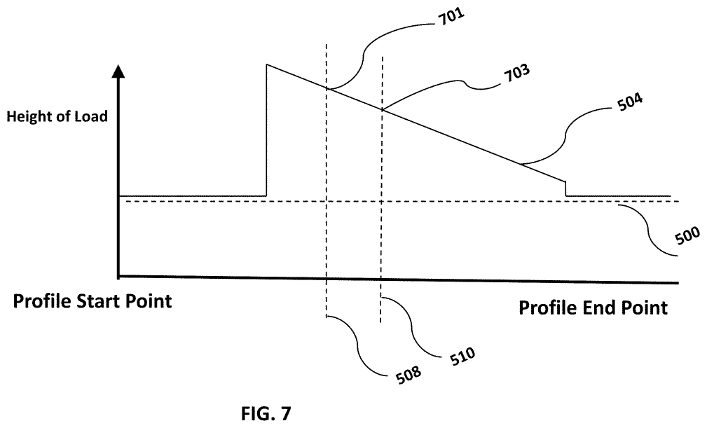

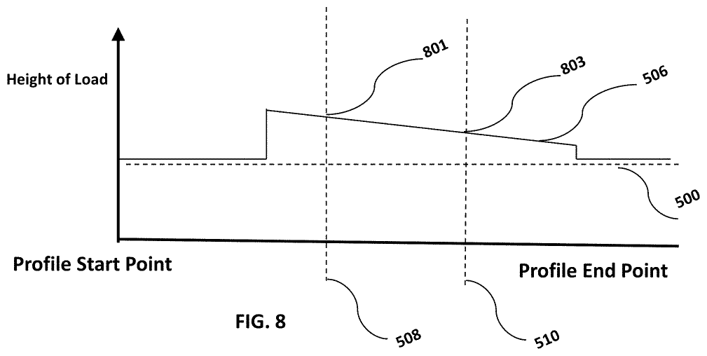

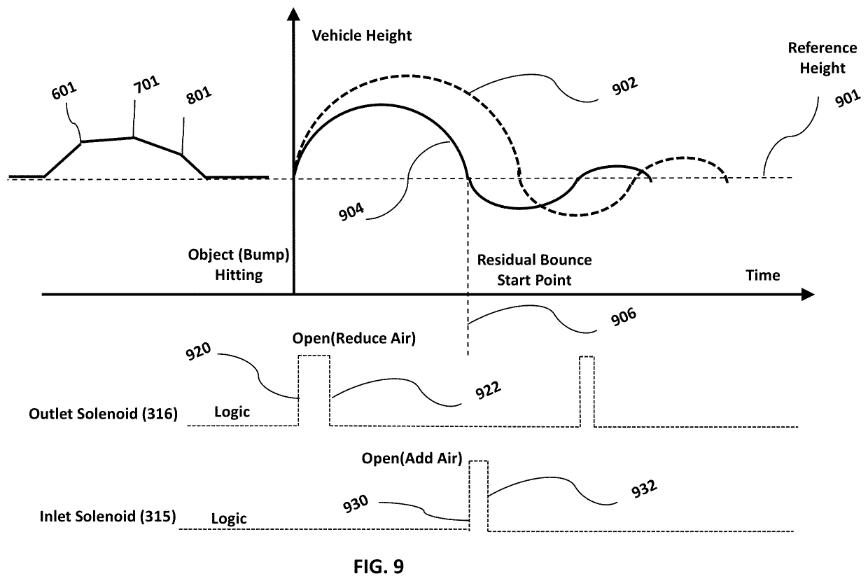

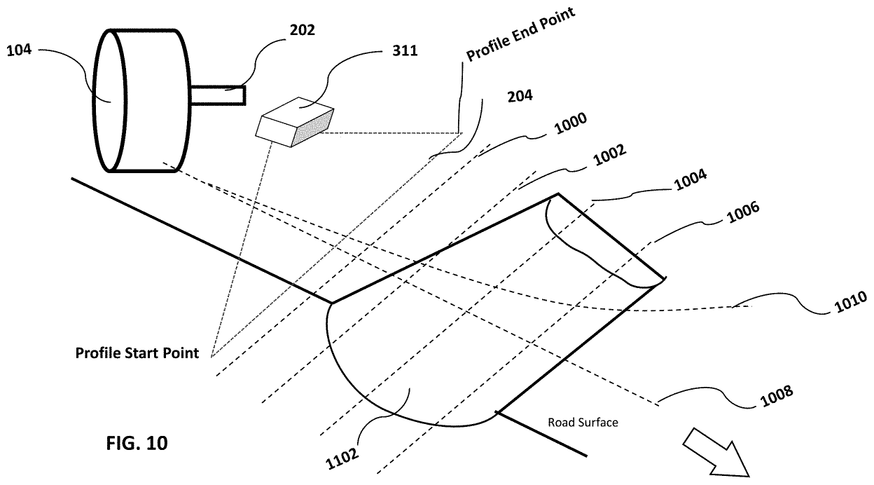

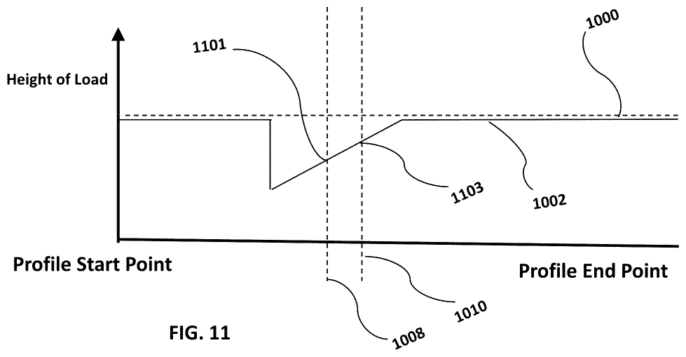

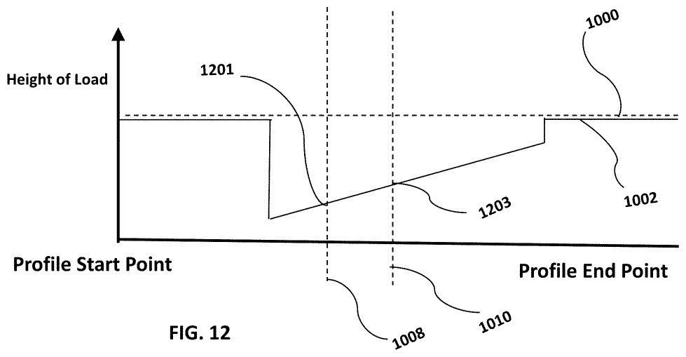

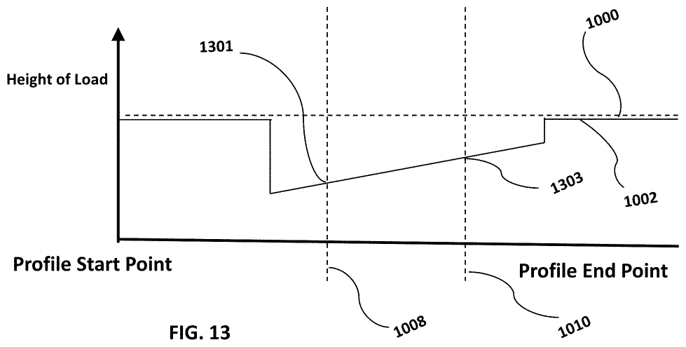

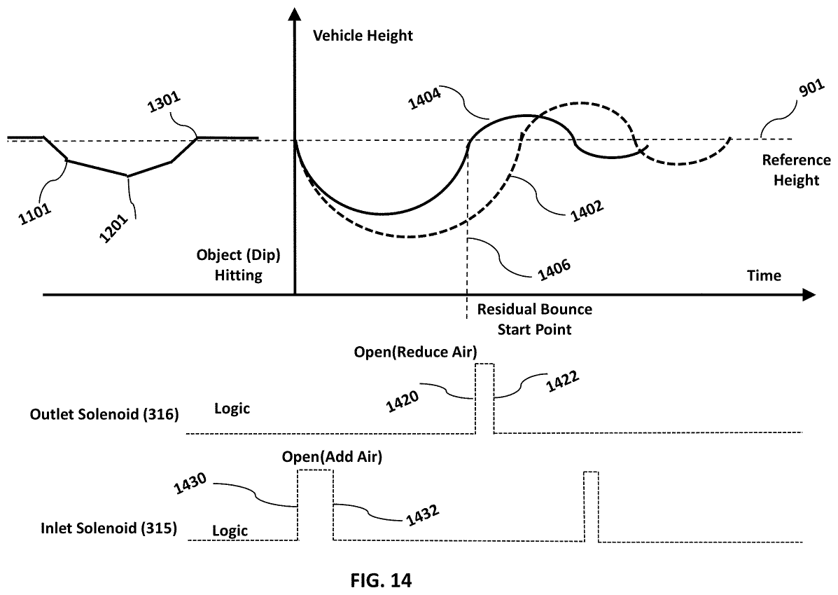

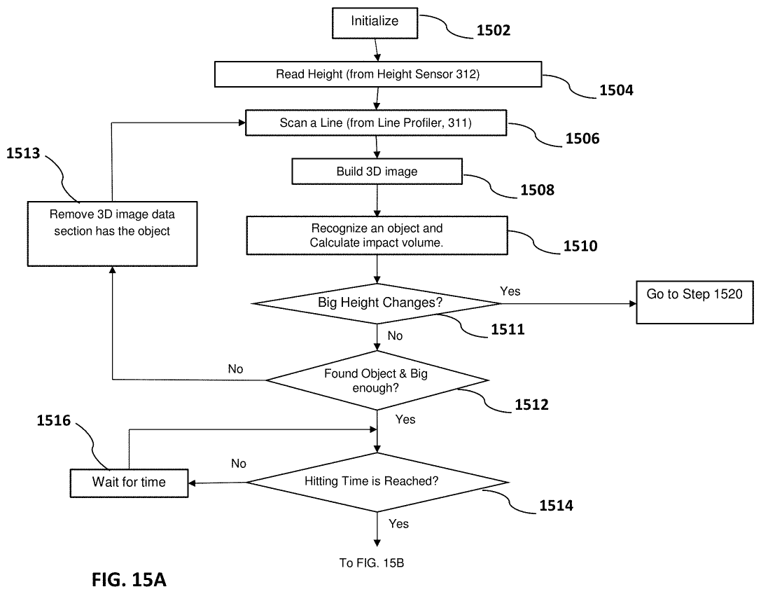

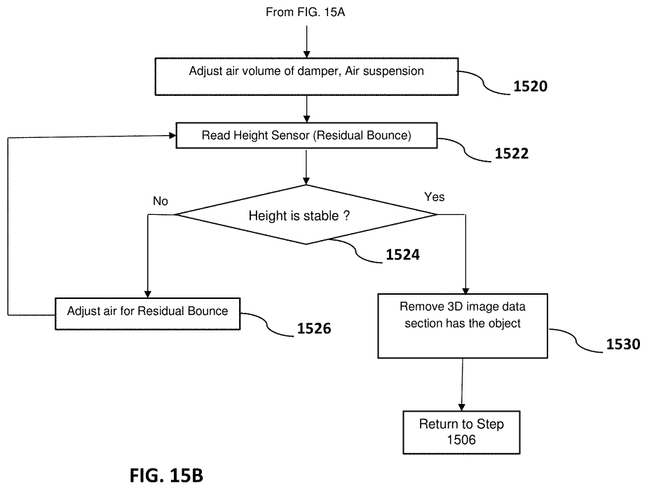

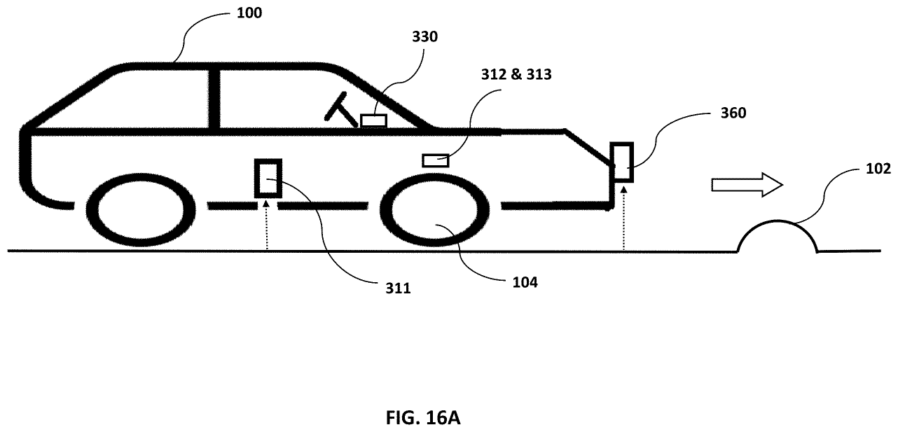

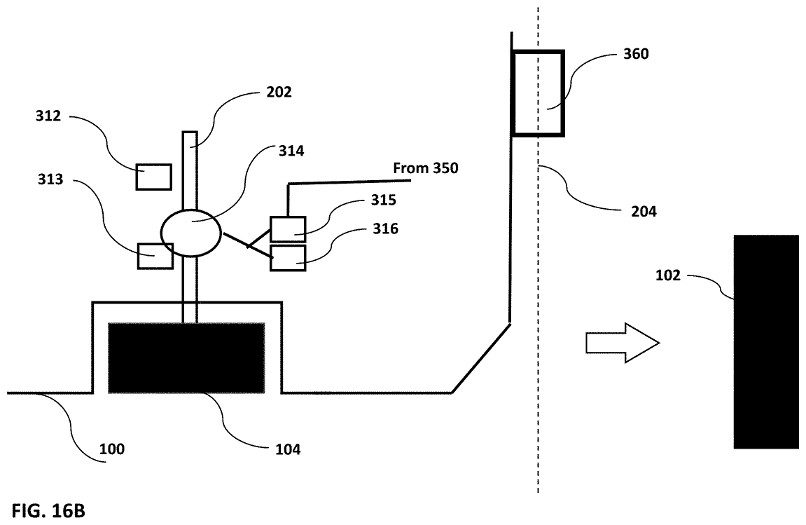

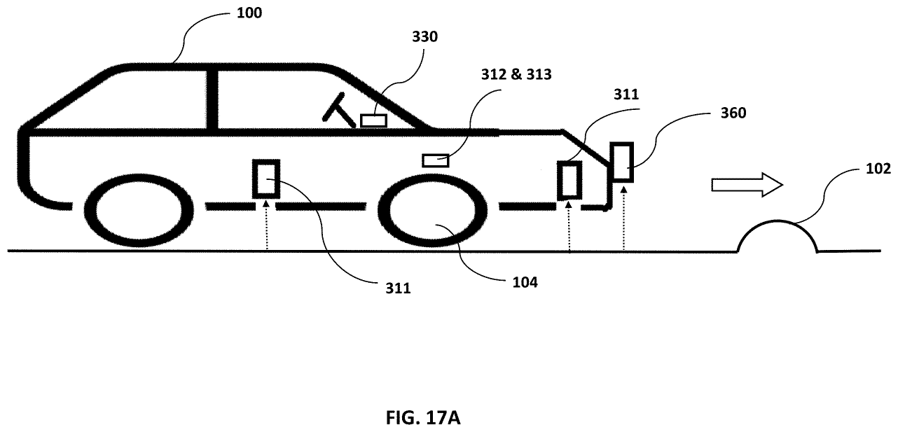

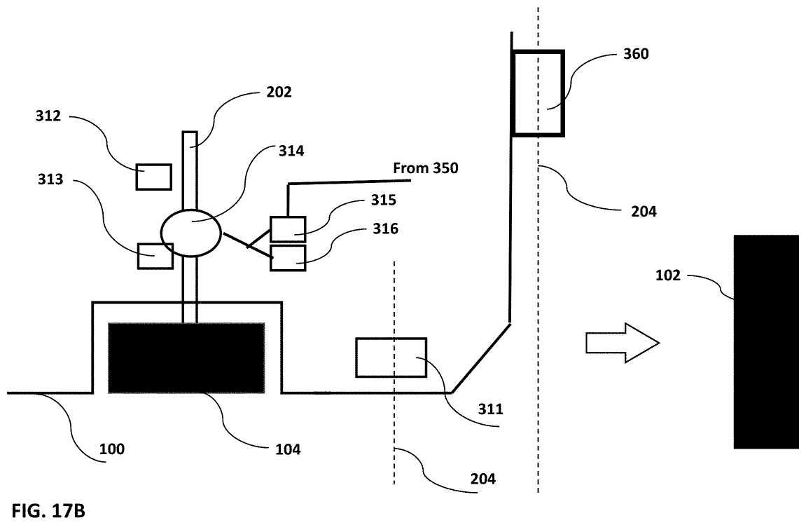

When the Vehicle (100) goes straight through the bump (102), As shown in FIG. 6, the point where the scan line 502 meets the line 508 passing by the car is the first center of hitting point 601. In FIG. 7, the point where the scan line 504 and the line 508 passing by the car meet is the second center of hitting point 701. FIG. 8 is the third center of hitting point 801, where the scan line 506 and the line 508 passing by the vehicle meet.

When the Vehicle (100) makes a turn through the bump (102), As shown in FIG. 6, the point where the scan line 502 meets the line 510 passing by the car is the first center of hitting point 603. In FIG. 7, the point where the scan line 504 and the line 510 passing by the car meet is the second center of hitting point 703. FIG. 8 is the third center of hitting point 803, where the scan line 506 and the line 510 passing by the vehicle meet.

In this example, all scan lines up to scan line 506 were scanned before the car hit the bump. As shown in FIG. 9, a dotted line 902 is a graph showing the vibration in the same situation of an existing vehicle that does not apply the present disclosure, and a graph 904 shows the magnitude of vibration and the vibration time when the present disclosure is applied.

901 is the reference height. This value is the value received from the height sensor module (312) when the vehicle is started and the vehicle starts driving for the first time. The peak point of the bump is 701, and the magnitude of the expected vibration is compared with the 901 obtained in the previous scan and determined in proportion to the speed of the vehicle. That is, if the height difference is large and the speed is high, the magnitude of the vibration is large. When the speed of the car is fast, the time period or duration of the valve opening is lengthened, and when the speed is slow, the time period of the valve opening is shortened. The similar operation of the valve is also applied to the residual vibration and the valve opening duration can be adjusted to be smaller in proportion to the opening time of the initial value opening.

The image processing & control unit (320) analyzes the transmitted data, monitors the speed of the vehicle, and adjusts the amount of air in the strut when the hitting time is reached. As shown in FIG. 9, the image processing & control unit (320) uses the Outlet Solenoid valve (316), and open and discharge air. The amount of air discharged is a pre-calculated amount and is equal to the time between 920 and 922.

Residual vibration or residual bounce 906 is generated after the car has finished bumping. At this time, the car is bounced, so the height goes down than reference. As shown in FIG. 9, the image processing & control unit (320) opens the Inlet Solenoid valve (315) and injects air. In embodiments, the image processing & control unit (320) collects the vehicle's (100) speed and the maximum height of the wheel while passing the bump (102), and uses this information to calculate the amount of air. The amount of air injected is a pre-calculated amount and is equal to the time between 930 and 932.

While adjusting the residual vibration, the image processing & control unit (320) monitors the height sensor module (312) and sees that the residual vibration is turned off when it is stable. After that, in embodiments, the image processing & control unit (320) delete the 3D data and then collects data from the Line Profiler (311), Steering Wheel Sensor Module (330), and Speed Sensor Module (340) to detect new objects.

As shown in FIG. 10, another example is taken that the vehicle wheel (104) of the Vehicle (100) goes straight or makes a turn through the dip (1102). FIG. 11 to FIG. 13 show the image data of the road condition by time scanned from the line profiler (311).

When the Vehicle (100) goes straight through the dip (1102), As shown in FIG. 11, the point where the scan line 1002 meets the line 1008 passing by the car is the first center of hitting point 1101. In FIG. 12, the point where the scan line 1004 and the line 1008 passing by the car meet is the second center of hitting point 1201. FIG. 13 is the third center of hitting point 1301, where the scan line 1006 and the line 1008 passing by the vehicle meet.

When the Vehicle (100) makes a turn through the dip (1102), As shown in FIG. 11, the point where the scan line 1002 meets the line 1010 passing by the car is the first center of hitting point 1103. In FIG. 12, the point where the scan line 1004 and the line 1010 passing by the car meet is the second center of hitting point 1203. FIG. 13 is the third center of hitting point 1303, where the scan line 1006 and the line 1010 passing by the vehicle meet.

In this example, all scan lines up to scan line 1006 were scanned before the car hit the dip. As shown in FIG. 14, a dotted line 1402 is a graph showing the vibration in the same situation of an existing vehicle that does not apply the present disclosure, and a graph 1404 shows the magnitude of vibration and the vibration time when the present disclosure is applied.

The lowest point of the dip is 1101, and the magnitude of the expected vibration is compared with the 901 obtained in the previous scan and determined in proportion to the speed of the vehicle.

As shown in FIG. 14, the image processing & control unit (320) uses the Inlet Solenoid valve (315), open and charge air. The amount of air charged is a pre-calculated amount and is equal to the time between 1430 and 1432.

Residual vibration or residual bounce 1406 is generated after the car has finished dipping. At this time, the car is bounced, so the height goes up than reference. As shown in FIG. 14, the image processing & control unit (320) opens the Outlet Solenoid valve (316) and discharge air. In embodiments, the image processing & control unit (320) collects the vehicle's (100) speed and the minimum height of the wheel while passing the dip (1102), and uses this information to calculate the amount of air. The amount of air discharged is a pre-calculated amount and the amount is equal to the time between 1420 and 1422.

FIG. 15A and FIG. 15B are a flowchart of the operation. When the vehicle is started, the Image Processing & Control Module (320) initializes (step 1502) the device. When initializing, parameters that are helpful when controlling the vehicle are read from the pre-set from the memory, such as the default weight of the car, the optimal pressure value of the tire (104), the width of the tire, and the radius of the tire. In Step 1504, in embodiments, the Image Processing & Control Module (320) sets the default height of the wheel by reads a value from the height sensor module (312) after the driver puts the gear to Drive Mode (“D”) when driving for the first time after starts the engine. This is used as the reference height 901. From this point on, the Image Processing & Control Module (320) collects data from the line profiler (311) (Step 1506). For example, the scanned data is shown in FIGS. 6-8 or FIGS. 11-13. In embodiments, it does not scan again when the car is stopped. This is to prevent the storage of duplicate data.

In Step 1508, the data of the steering wheel angle sensor module (330) & vehicle speed sensor module (340) is added to the data received by the line profiler (311), and a 3D image is created and saved. In Step 1510, the saved 3D image data is analyzed and when the corresponding wheel passes the path received by the steering wheel angle sensor module (330), it knows whether there is a bump or a dip, and calculates how much impact it will have. The basic calculation is the difference between the reference height 901 and the largest height of the object (Bump or Dip) after passing the object (Bump or Dip), and it is determined in proportion to the speed of the vehicle. For example, 701 or 1201 for straight, or 703 or 1203 for a turn. That is, if the height difference is large and the speed of the vehicle is fast, the magnitude of vibration is large.

In Step 1511, in embodiments, when the object is big and the vehicle hits an object before analyzing the bump or dip, that is, when the value of the Height Sensor module (312) changes significantly, the difference of the reference height 901 and the first height of the object (for example, 601 or 1101 for straight, or 603 or 1103 for a turn) can be used to determine the amount of air to be adjusted in proportion to the speed of the car.

In Step 1512, in embodiments, if the detected object (102 or 1102) is small, the contact area between the object (102 or 1102) and the tire (104) is small, or the vehicle speed is slow, it can be ignored, and the corresponding 3D image data is deleted from the memory (Step 1513). Conversely, if it is determined that a large vibration can be made, go to step 1520. If it has not hit an object in time, wait until it hit an object (steps 1514 & 1516).

In Step 1520, the vibration is minimized by adjusting the strut (314) appropriately for the initial collision. As described above, the residual vibration is 906 or 1406 (Step 1522 & Step 1524) and when the height of the Height Sensor module (312) is stabilized, the image processing & control unit (320) deletes the corresponding 3D image data from the memory (step 1530) and proceed to Step 1506 to perform a new operation. The image processing & control unit (320) properly adjusts the strut (314) until the height of the height sensor module (312) is stabilized, as seen in FIG. 9 & and FIG. 14 (step 1526).

Since this device can be adjusted for each axle, wheel components (310) sets do not need to be installed in both the rear and front axles. Furthermore, if wheel components (310) sets are installed in both of the axels, both (driver and passenger) wheel components (310) in one of the two axles can be disabled. This device uses the line profiler (311) to cover the range from the Profile start point to the Profile end point (see FIG. 5 and FIG. 10), so it works even when rotating.

FIG. 16A is a side view of a vehicle comprising example sensors that can be used for an ECAS system according to other embodiments where a wide-angle line profiler (image sensor, 360) has been added instead of front line profilers (311) of FIG. 1. FIG. 16B is a top view of a portion of the vehicle comprising example sensors that can be used for the ECAS system according to other embodiments where the wide-angle line profiler (image sensor, 360) has been added instead of front line profilers (311) of FIG. 2.

In these embodiments, a wide-angle line profiler (image sensor, 360) is added for cost reduction and easy maintenance of this system. For example, the Wide-angle Line Profiler (360) can be installed at the front bumper of the vehicle (e.g., around the center of the front bumper) to replace the front line profilers (311) on the front Passenger Side and Driver Side. The image processing & control unit (320) can divide the image (height info) input from the Wide-angle Line Profiler (360) in half, and the half takes the role of the line profiler (311) of the Passenger Side. And the image of the other half takes the role of the line profiler (311) on the Driver Side. The wide-angle Line Profiler (360) can play the role of two line profilers (311) as one device. The Line Profiler (360) may be a wide-angle line profiler that scans a distance wider than the width of the vehicle.

FIG. 17A is a side view of a vehicle comprising example sensors that can be used for an ECAS system according to other embodiments where a wide-angle line profiler (image sensor, 360) has been added and existing front line profilers (311) have been disabled. FIG. 17B is a top view of a portion of the vehicle comprising example sensors that can be used for the ECAS system according to other embodiments where a wide-angle line profiler (image sensor) 360 has been added and existing front line profilers (311) have been disabled. According to the embodiments of FIGS. 17A and 17B, the Wide-angle Line Profiler (360) is installed while the front line profilers (311) are installed at their positions with their functionality being disabled, as the Wide-angle Line Profiler (360) replaces the functionality of the front line profilers (311). According to these embodiments, the Wide-angle Line Profiler (360) can be easily installed to the existing ECAS system that includes the front line profilers (311), without the need of removing the front line profilers (311).

If the height info received from the line profiler (311 or 360) is higher than the height of the underside of the bumper from the ground due to heavy snow or abnormal weather, the Image processing & control unit (320) can ignore the information from Line Profiler (311 or 360) for safety and controls the wheel vibration only use information from the height sensor module (312).

As alternatives, 1) if one or more sensors are installed on the rear of the vehicle wheel, they can be applied even when reversing, and 2) the system can use a two-dimensional image sensor.

Those skilled in the art will appreciate that, in some embodiments, additional components and/or steps can be utilized, and disclosed components and/or steps can be combined or omitted. For example, although some embodiments are described in connection with a robotic surgery system, the disclosure is not so limited. Systems, devices, and methods described herein can be applicable to medical procedures in general, among other uses. As another example, certain components can be illustrated and/or described as being circular or cylindrical. In some implementations, the components can be additionally or alternatively include non-circular portions, such as portions having straight lines. As yet another example, any of the actuators described herein can include one or more motors, such as electrical motors. As yet another example, in addition to or instead of controlling tilt and/or pan of a camera, roll (or spin) can be controlled. For example, one or more actuators can be provided for controlling the spin.

The foregoing description details certain embodiments of the systems, devices, and methods disclosed herein. It will be appreciated, however, that no matter how detailed the foregoing appears in text, the systems, devices, and methods can be practiced in many ways. The use of particular terminology when describing certain features or aspects of the disclosure should not be taken to imply that the terminology is being redefined herein to be restricted to including any specific characteristics of the features or aspects of the technology with which that terminology is associated.

It will be appreciated by those skilled in the art that various modifications and changes can be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the figures can be combined, interchanged, or excluded from other embodiments.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

Directional terms used herein (for example, top, bottom, side, up, down, inward, outward, etc.) are generally used with reference to the orientation or perspective shown in the figures and are not intended to be limiting. For example, positioning “above” described herein can refer to positioning below or on one of sides. Thus, features described as being “above” may be included below, on one of sides, or the like.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations).

The term “comprising” as used herein is synonymous with “including,” “containing,” or “characterized by,” and is inclusive or open-ended and does not exclude additional, unrecited elements or method steps.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Language of degree used herein, such as the terms “approximately,” “about,” “generally,” and “substantially” as used herein represent a value, amount, or characteristic close to the stated value, amount, or characteristic that still performs a desired function and/or achieves a desired result. For example, the terms “approximately”, “about”, “generally,” and “substantially” may refer to an amount that is within less than 10% of, within less than 5% of, within less than 1% of, within less than 0.1% of, and/or within less than 0.01% of the stated amount.

It will be further understood by those within the art that any disjunctive word and/or phrase presenting two or more alternative terms, whether in the description, claims, or drawings, can be understood to contemplate the possibilities of including one of the terms, either of the terms, or both terms. For example, the phrase “A or B” will be understood to include the possibilities of “A” or “B” or “A and B.” Further, the term “each,” as used herein, in addition to having its ordinary meaning, can mean any subset of a set of elements to which the term “each” is applied.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the present disclosure.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

The above description discloses embodiments of systems, apparatuses, devices, methods, and materials of the present disclosure. This disclosure is susceptible to modifications in the components, parts, elements, steps, and materials, as well as alterations in the fabrication methods and equipment. Such modifications will become apparent to those skilled in the art from a consideration of this disclosure or practice of the disclosure. Consequently, it is not intended that the disclosure be limited to the specific embodiments disclosed herein, but that it cover all modifications and alternatives coming within the scope and spirit of the subject matter embodied in the following claims.

What is claimed is:

1. A method of controlling an air suspension of a vehicle for reducing shock and vibration when the vehicle passes a bump or a dip, the method comprising:
providing a vehicle comprising:
a vehicle wheel,
a vehicle body,
an air suspension connecting the vehicle wheel and the vehicle body and supporting the vehicle body, the air suspension comprising an air strut, an air inlet valve, and an air outlet valve,
an air compressor supplying air to the air strut via the air inlet valve,
a plurality of sensors comprising a vehicle speed sensor, a steering angle sensor, a height sensor and an air pressure sensor of the strut,
a line profiler comprising an image sensor located in front of the vehicle wheel such that the line profiler acquires a profile of a road on which the vehicle wheel passes,
a processor configured to process information from the plurality of sensors and the line profiler for predicting the vehicle's vibration and further configured to control operations of one or more of the air inlet valve, the air outlet valve and the air strut for reducing shock and vibration caused by the bump or dip;
while the vehicle moves, scanning, by the line profiler, a road on which the vehicle moves for acquiring the profile of the road and locating a bump or a dip;
processing, by the processor, the information from the plurality of sensors and the profile of the road; and
controlling, by the processor, the operation of the air suspension by increasing or decreasing air supplied to the air strut via the air inlet valve or discharged from the strut via the air outlet valve based on the profile of the road and the speed of the vehicle for reducing vibration when the vehicle passes the bump or dip.

2. The method of claim 1, further comprising:
after passing the bump or dip, further controlling, by the processor, the operation of the air suspension by increasing or decreasing air supplied to the air strut or discharged from the strut based on the wheel height and the vehicle speed for reducing a residual vibration.

3. The method of claim 1, further comprising:
when starting an operation of the vehicle, detecting a height with the wheel height sensor for setting the detected wheel height as a reference height, and detecting an air pressure of the strut with the air pressure sensor for setting the detected air pressure as a reference air pressure,
wherein controlling is performed further based on the reference height and the reference air pressure.

4. A non-transitory computer readable medium storing instructions for performing the method of claim 1.

5. An air suspension system for use with a vehicle, the system comprising:
an air suspension connecting a vehicle wheel and a vehicle body and supporting the vehicle body, the air suspension comprising an air strut, an air inlet valve, and an air outlet valve;
an air compressor configured to supply air to the air strut via the air inlet valve;
a plurality of sensors comprising a vehicle speed sensor, a steering angle sensor, a wheel height sensor and an air pressure sensor of the strut;
a line profiler comprising an image sensor located in front of the vehicle wheel and configured to acquire a profile of a road on which the vehicle wheel passes to locate a bump or a dip; and
a processor configured to process information from the plurality of sensors and the line profiler for predicting the vehicle's vibration and further configured to control operations of one or more of the air inlet valve, the air outlet valve and the air strut for reducing shock and vibration caused by the bump or dip.

6. A vehicle comprising the air suspension system of claim 5.

7. The vehicle of claim 6, wherein the vehicle is an electric vehicle, a combustion based vehicle, a hybrid vehicle or a motor cycle.

8. An air suspension system for use with a vehicle, the system comprising:
an air suspension connecting a vehicle wheel and a vehicle body and supporting the vehicle body, the air suspension comprising an air strut, an air inlet valve, and an air outlet valve;
an air compressor configured to supply air to the air strut via the air inlet valve;
a plurality of sensors comprising a vehicle speed sensor, a steering angle sensor, a wheel height sensor and an air pressure sensor of the strut;
a first line profiler comprising an image sensor located on a front portion of the vehicle and configured to acquire a profile of a road on which the vehicle wheel passes to locate a bump or a dip; and
a processor configured to process information from the plurality of sensors and the first line profiler for predicting the vehicle's vibration and further configured to control operations of one or more of the air inlet valve, the air outlet valve and the air strut for reducing shock and vibration caused by the bump or dip.

9. The air suspension system of claim 8, further comprising a second line profiler comprising an image sensor located in front of the vehicle wheel such that the second line profiler acquires a profile of a road on which the vehicle wheel passes.

10. The air suspension system of claim 9, wherein the processor is configured to disable the second line profiler when the first line profiler is enabled.

11. The air suspension system of claim 9, wherein the processor is configured to enable only one of the first line profiler or the second line profiler.

12. The air suspension system of claim 8, wherein the front portion of the vehicle comprises a front bumper of the vehicle.
